(19) United States
(12) Patent Application Publication
(10) Pub. No.: US 2005/0170248 A1
(43) Pub. Date: Aug. 4, 2005

(54) Modified lithium ion polymer battery

(76) Inventors: Guiping Zhang, Shenzhen (CN); Yongyang Yu, Shenzhen (CN); Torng Jinn Lee, Hsin-Chu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/048,826

(22) Filed: Feb. 3, 2005

Related U.S. Application Data
(63) Continuation-in-part of application No. 09/933,838, filed on Aug. 22, 2001.

(51) Int. Cl. H01M 4/62; H01M 4/66; H01M 2/02; H01M 4/50; H01M 4/52; H01M 10/40

(52) U.S. Cl. 429/217; 429/245; 429/317; 429/316; 429/176; 429/231.3; 429/223; 429/224; 429/307

(57) ABSTRACT

A Modified Lithium Ion Polymer Battery, comprising multiple positive electrode sheets and multiple negative electrode sheets formed by blending binder with positive or negative electrode powder, respectively, and then coating or rolling with resulting mixture over copper foil or aluminum foil. Binder can be prepared from the following three components: (a) 0.1 wt %˜95 wt % of polyvinylidene fluoride, (b) 0.1 wt %˜90 wt % of amodified polyacrylates, (c) 0.1 wt %˜85 wt % of a modified polyethylene or polydienes, and choosing one or any two from them mixing in a proper ratio. The invention still provides a separation membrane, which is a non-porous polyalkylene oxide film, or a film made by coating a blend of polyalkylene oxide and polyvinylidene fluoride (PVDF), or a micro-porous polypropylene film, or a three-layered composite film of polypropylene, polyethylene and polypropylene. Fabrication of modified lithium ion polymer battery as following process: (1) positive and negative electrode sheets are laminated with separation membrane and rolled in an alternative and isolated manner to form an overlap stack; (2) positive and negative electrode sheets are welded with positive and negative collectors, respectively; and (3) the whole laminate is assembled with an aluminum plastic membrane.

### REFERENCES TO RELATED APPLICATIONS

This patent application is a Continuation-in-Part application of Ser. No.09/933,838, filed on 22 Aug. 2001.

### BACKGROUND OF THE INVENTION

1. Field of the invention

The present invention relates to a modified ion polymer battery comprising of multiple positive electrode sheets, multiple negative electrode sheets, a separating membrane, and using binder to bind them with.

2. Description of the Prior Art

As U.S. Pat. No.5,296,318disclosed a lithium pilymer battery based on Bellcore, wherein its collectors were made of copper and aluminum sieves, and a copolymer of polyvinylidene fluoride and hexafluoropropylene was used as the binder. Although such binder exhibited better binding power, but binding poorly to copper or aluminum foil. This was why polymer battery adopted copper or aluminum sieves as collectors. Under such circumstance, the binder could penetrate meshes of those sieves and adhered themselves as well as the copper and aluminum sieves to form positive and negative electrode sheets, respectively. In order to impart the binder a self-adhered, during heat rolling in the processing, a plasticizer, dibutyl phthalate, DBP, must be incorporated into the binder such that the binder could be blended with the positive and negative electrode powders, and thereby could be coated into a shape of film; otherwise, the film could not be processed and bonded through heat lamination, with copper and aluminum sieves. Furthermore, because of the incorporation of the plasticizer, the battery must undergo an extraction step to remove he plasticizer. This resulted into several disadvantages, such as rendering the fabricating of the battery a complicated process, increasing the cost of the production, and incomplete removal of plasticizer.

### SUMMARY OF THE INVENTION

In order to overcome the above-mentioned disadvantages, the invention provides a modified lithium ion polymer battery based essentially on the modification of the binder. Hence application of the binder on multiple positive and negative electrode sheets, as well as in combination with a separation membrane laminated between multiple positive and negative electrode sheets, characterized in that there is no more plasticizer necessary to be incorporated in the modified lithium ion polymer battery according to the invention, thus any extraction step can be omitted, and as a result that copper or aluminum foil is substituted for copper or aluminum sieves as the controller.

The binder above-mentioned can absorb an amount of electrolyte and thereby can form a colloid that exhibits an excellent high-low temperature characteristics (T_{g}: −40═; heat cracking temperature: 300□), that can binder shows good adhesion against the copper and aluminum foil such that it will not be affected by the electrolyte and no dislodging of active positive and negative substance from the collectors will occur, and that the binder can impart said positive and negative electrode sheets a superior flexibility.

The invention provides a modified lithium ion polymer battery comprising of multiple positive electrode sheets, multiple negative electrode sheets, and a separating membrane. Wherein said positive and negative electrode sheets are formed by blending positive and negative powder with a modified binder, and then coating or rolling the resulting mixture over copper and aluminum foil. Battery is fabricated by winding said multiple positive and negative electrode sheets are laminated with a separating membrane, and rolled to form an overlap stack. Then, welding multiple positive and negative electrode sheets with positive and negative collectors, respectively. Finally, the whole laminate is assembled with an outer membrane.

The lithium ion polymer battery according to the invention exhibits following characteristics or advantages:
(1) High capacity and high density.
(2) Processes a long cycle life and small internal resistance.
(3) Can be used in a wide suitable range of temperature.
(4) Shows a high safety (non-explosive and un-ignitable).
(5) Blending, coating and laminating can be accomplished under normal moist (very low moisture) environment.
(6) Heat lamination is omitted in the process according to the modified binder provided by the invention.
(7) High rate of discharging ability and low self-discharging property.

### BRIEF DESCRIPTION OF THE DRAWINGS

FIG. 1 is a schematic view showing the alternative and isolated arrangement of multiple positive and negative electrode sheets with a separating membrane laminated

### DETAILED DESCRIPTION OF THE PREFERRED EMBODIMENT

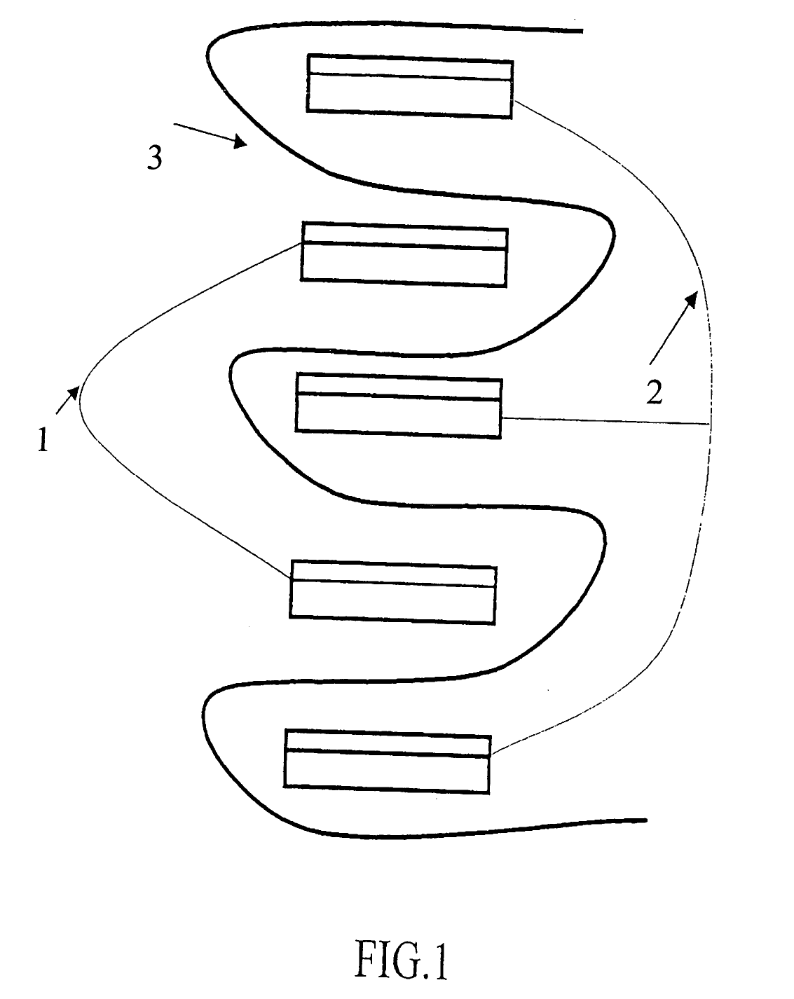

As FIG. 1 shows, the invention provides a modified lithium ion polymer battery and a process for fabricating the same. In one aspect, the modified lithium ion polymer battery according to the invention comprises multiple positive electrode sheets 1, multiple negative electrode sheets 2, and a separating membrane 3, wherein positive electrode sheets 1 and negative electrode sheets 2 are blended with a binder that prepared from the following three fluoride:
1. 0.5 wt %˜95 wt % of polyvinylidene fluoride;
2. 0.1 wt %˜90 wt % of a modified polyacrylates, which is a substance made by cc-polymerizing more than 60 wt % of a carboxylic acid or carboxylic acid ester as the major constituent selected from a group consisting of acrylonitrile, 2-ethylhexyl methacrylate, acrylic acid, methacrylic acid, methyl acrylate, methyl methacrylate, ethyl acrylate, butyl acrylate, butyl methacrylate, ethyl acrylate, hydroxyethyl acrylate, hydroxypropyl acrylate, itaconic acid and the like; and 0˜40 wt % of a second constituent selected from styrene and butadiene, into a copolymer, and subsequently neutralizing part or all of the carboxylic groups on said copolymer;
3. 0.5 wt %˜85 wt % of a modified polyethylene or polydienes; and choosing one or any two or all from above-mentioned three kind of fluoride mixing in a proper ratio. Said binder system exhibits an excellent high and low temperature characteristics (T_{g}: −40□; heat cracking temperature: 300□), and can absorb an amount of electrolyte to form a colloid that shows good conductivity of lithium ion. Furthermore, during the fabrication of the battery according to the invention, the binder can impart positive and negative electrode sheets superior flexibility.

In fabrication of the modified lithium ion polymer battery according to the invention, a separation membrane is used in the fabrication, which can be selected from a group consisting of following:
1. A non-porous polyalkylene oxide film.
2. A film formed by blending and coating polyalkylene oxide and polyvinylidene fluoride.
3. A film formed by blending and coating polyacrylates and polyvinylidene fluoride.
4. A micro-porous polypropylene film.
5. A micro-porous three-layered polypropylene, polyethylene and polypropylene composite film.

In fabrication of the modified lithium ion polymer battery according to the invention, the above-described binder system is blended with positive or negative powder at first, and the resulted mixture is coated as slurry, or compressed as powder, or rolled over copper and aluminum foil used as collectors, and thereby forms positive electrode sheets and negative electrode sheets, respectively. The above process can be done under low temperature and low moisture.

As shown in FIG. 1, in one embodiment, the modified lithium ion polymer battery according to the invention comprises multiple positive electrode sheets 1, multiple negative electrode sheets 2, and a separation membrane 3; All of above are rolled with in a alternative and isolation manner, and form an overlap stack. Then, electrode leads from positive electrode sheets 1 and negative electrode sheets 2 are welded together, respectively. Thus-welded electrode leads are then welded with positive and negative contacts out of the battery, respectively, without heat lamination. Thereafter, positive electrode sheets 1 or negative electrode sheets 2 are welded together. An aluminum plastic film is used to firstly sealing over three sides of the battery and then the electrolyte is poured in. Finally, the last side is sealed and the whole battery is aged, evacuated and secondary sealed to yield the modified lithium ion polymer battery according to the invention.

The active material used in positive electrode sheet I of the modified lithium ion polymer battery according to the invention is a composite oxide of lithium and transition metals, such as LiCoO₂, LiMn₂O₄, LiNiO₂, LiNiₓCo₁₋ₓO₂ and the like. The active materials used in negative electrode sheet 2 of the modified lithium ion polymer battery according to the invention is carbon powder, such as mesophase carbon micro-beads (MCMB), natural graphite and modified graphite products, petroleum coke and modified coke products, and as well as hard carbon materials.

The electrolyte used in the modified lithium ion polymer battery according to the invention comprises:
1. 3 wt %˜12 wt % of lithium salts selected from a group consisting of LiPF₆, LiAsF₆, LiClO₄, Lin(CF₃SO₂)₂, LiBF₄, LiSbF₆, LiCF₃SO₃ and the like;
2. 2.5 wt %˜60 wt % of organic solvent such as ethylene carbonate, propylene carbonate, dimethyl carbonate, diethoxyethane, diethyl carbonate, dimethoxyethane, dipropyl carbonate and the like;
3. 15 wt %˜40 wt % of a copolymer; and the concentration of above lithium salt in solvent is 0.1˜2M.

The invention will be further illustrated in more detailed by way of the following non-limiting examples. Modification and changes thereto as can be readily done by persons skilled in the art are intended to be encompassed in the scope of the invention.

### EXAMPLE 1

To a stainless steel can, which was charged 2 wt % of polyvinylidene fluoride, 2 wt % of modified polyethylene, 96 wt % of carbon powder and 40 wt % of N-methyl pyrrolidone. The resulting mixture was mixed in a high speed mixer into a homogeneous slurry. The slurry was then used to coat over a copper foil as the collector. The coated copper foil was dried in an oven at 100□˜200□ to form a negative electrode sheet 2 which was cut into desired size.

### EXAMPLE 2

Following the procedure as described in Example 1, to a stainless steel can, which was charged 2 wt % of polyvinylidene fluoride, 1 wt % of polycrylate, 7 wt % of conductive carbon black such as acetylene black, 90 wt % of lithium cobaltate and 40 wt % of N-methyl pyrrolidone. The resulting mixture was mixed in a high speed mixer into a homogeneous slurry. The Slurry was then used to coat over an aluminum foil as the collector. The coated foil was dried in an oven at 150□˜200□ to form a positive electrode sheet 1 which was cut into desired size.

### EXAMPLE 3

Following the procedure as described in Example 1, to a stainless steel can, which was charged 1 wt % of polyacrylate, 1 wt % of modified polythylene, 6 wt % of conductive carbon black, 92 wt % of lithium cobaltate and 35 wt % of N-methyl pyrrolidone. The sesulting mixture was mixed in a high speed mixer into a homogeneous slurry. The slurry was then used to coat over an aluminum foil as the collector. The coated foil was dried in an oven at 180□˜200□ to form a positive electrode sheet I which was cut into desired size.

### EXAMPLE 4

Following the procedure as described in Example 1, to a stainless steel can, which was charged 1.8 wt % of polyvinylidene fluoride, 0.48 wt % of polyacrylate, 0.5 wt % of modified polyethylene. 7.5 wt % of conductive carbon black, 89.72 wt % of lithium cabaltic acid and 45 wt % of N-methyl pyrrolidone. The resulting mixture was mixed in a high speed mixer into a homogeneous slurry. The slurry was then used to coat over a aluminum foil as the collector. The coated foil was dried in an oven at 180□˜200□ to form a positive electrode sheet I which was cut into desired size.

### EXAMPLE 5

To a stainless steel can, which was charged 3.5 wt % of modified polyethylene, 96.5 wt % of carbon powder and 95 wt % of N-methyl pyrrolidone. The resulting mixture was mixed in a high mixer into a homogeneous slurry. The slurry was then used to coat over a copper foil as the collector. The coated copper foil was dried in an oven at 200□ to form a positive electrode sheet 1 that was cut into desired size.

### EXAMPLE 6

A laminate was formed from the positive electrode sheets 1 consisted of 3.5 wt % of modified polyethylene and 96.5 wt % of carbon powder prepared as in Example 5, the negative electrode sheets 2 consisted of 2 wt % of polyvinylidene fluoride, 2 wt % of modified polyethylene and 96 wt % of carbon powder prepared as in Example 1, and a separation membrane 3 consisted of a blend of non-porous polyethylene oxide and polyvinylidene fluoride.

### COMPARATIVE EXAMPLE

A 700 mAh lithium ion polymer battery according to the invention as prepared in the above Example 6 was compared with a similar lithium ion polymer battery prepared by the above mentioned Bellcore technique as follows:

| | Internal | | Capacity at | Capacity | Puncturing the battery |
|---|---|---|---|---|---|
| Type of | resistance | Capacity | −20□ | after 4 hr at | with a nail |
| battery | (mΩ) | (mAh) | (mAh) | 90□ (mAh) | of 2 mm diameter |
| The invention | 28 | 700 | 410 | 680 | Elevation of the battery |
| | | | | | temperature, no ignition, no |
| | | | | | explosion |
| Bellcore | 50 | 540 | 40 | 0 | Temperature elevation, smoke |
| | | | | | evolution |

accordingly, the invention provides a modified lithium ion polymer battery that has a high capacity, a high density, a long cycle life, a small internal resistance, a wide suitable temperature range, a high discharging capability, a low self-discharging property and high safety.

It is understood that the invention may be embodied in other forms without departing from the spirit thereof. Thus, the present examples and embodiments are to be considered in all respects as illustrative and not restrictive, and the invention is not to be limited to the details given herein.

1. A Modified Lithium Ion Polymer Battery comprising:
a binder, wherein said binder is prepared from the following three components: 0.5 wt %˜95 wt % of polyvinylidene fluoride, 0.1 wt %˜90 wt % of a modified polyacrylates, 0.1 wt %˜85 wt % of a modified polyethylene or polydienes, and then choosing one or any two or all from said three components, and then mixing in a proper ratio;
multiple positive electrode sheets, wherein said positive electrode sheets are formed by blending said binder with positive electrode powder, and then coating the resulting mixture on a copper foil or an aluminum foil used as the collector;
multiple negative electrode sheets, wherein said negative electrode sheets are formed by blending said binder with negative electrode powder;
coating the resulting mixture on a copper foil or an aluminum foil used as the collector;
said positive and negative electrode sheets are welded with positive and negative collectors, respectively;
a separation membrane, wherein said positive and negative electrode sheets are laminated with said separation membrane and rolled in alternative and isolation manner to form an overlap stack; and
said laminate is assembled with an outer membrane.

2. The Modified Lithium Ion Polymer Battery as claimed in claim 1, wherein said separation membrane is a non-porous polyalkylene oxide film, or a film made by coating a blend of polyalkylene oxide and polyvinylidene fluoride (PVDF), or a micro-porous polypropylene film, or a three-layered composite film of polypropylene, polyethy and polypropylene.

3. The Modified Lithium Ion Polymer Battery as claimed in claim 2, wherein said separation membrane is produced from polymethyl methacrylate and polyvinylidene fluoride.

4. The Modified Lithium Ion Polymer Battery as claimed in claim 1, wherein said modified polyacrylate is a substance made by co-polymerizing more than 60 wt % of a carboxylic acid or carboxylic acid ester as the major constituent selected from a group consisting of acrylonitrile, 2-ethylhexyl acrylate, acrylate acid, ,methacrylic acid, methyl acrylate, methyl methacrylate, ethyl acrylate, butyl acrylate, butyl methacrylate, octadecyl acrylate, hydroxyethyl acrylate, hydroxypropyl acrylate, itaconic acid and the like; and
0˜40 wt % of a second constituent selected from styrene and butadiene, into a copolymer, and subsequently neutralizing part or all of the carbioxylic groups on said copolymer.

5. The Modified Lithium Ion Polymer Battery as claimed in claim 1, wherein said active material used in the positive electrode of the modified lithium ion polymer battery according to the invention is a composite oxide of lithium and transition metal, such as LiCoO₂, LiMn₂O₄, LiNiO₂, LiNiₓCo₁₋ₓO₂ and the like; and
wherein said active material used in the negative electrode of the modified lithium ion polymer battery according to the invention is carbon powder, such as mesophase carbon micro-beads (MCMB), natural graphite, modified graphite products, petroleum coke, modified petroleum coke products, and as well as hard carbon materials.

6. The Modified Lithium Ion Polymer Battery as claimed in claim 1, wherein said electrolyte is prepared by mixing a lithium salt selected from the group consisting of LiPF₆, LiAsF₆, LiClO₄, LiN(CF₃SO₂)₂, LiBF₄, LiSbF₆, LiCF₃SO₃ and the like; there is an organic solvent selected from the group consisting of ethylene carbonate, propylene carbonate, dimethyl carbonate, diethoxyethane, diethyl cabomate, dimethoxyethane, dipropyl carbonate and the like; and
a co-polymer.

7. The Modified Lithium Ion Polymer Battery as claimed in claim 6, wherein the concentration of said lithium salt in said electrolyte is 0. 1˜2 M.

8. The Modified Lithium Ion Polymer Battery as claimed in claim 1, wherein said outer membrane is made from aluminum plastic.
